(19) United States
(12) Patent Application Publication
(10) Pub. No.: US 2003/0031963 A1
(43) Pub. Date: Feb. 13, 2003

(54) Photographic materials and process for their production

(75) Inventor: Henry H. Adam, Bedfordshire (GB)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/152,877

(22) Filed: May 21, 2002

(30) Foreign Application Priority Data
Aug. 2, 2001 (GB) 0118835.8

(51) Int. Cl. G03C 1/76; G03C 1/79; G03C 1/83; G03C 1/85; G03C 1/93

(52) U.S. Cl. 430/518; 430/213; 430/523; 430/536; 430/372; 430/432; 430/428; 430/941

(57) ABSTRACT

The invention provides an opaque reflective photographic material eg paper whose non image side is coated with a mordant in an amount to absorb during washing of the photographic material dyes that would contribute to staining of the final image.

The mordant may be a quaternary nitrogen-containing compound, preferably a quaternized vinylimidazole polymer or vinyl benzylammonium compound. The mordant may be coated at a lay down of from 100 to 400 mg/square ft, preferably from 150 to 300 mg/square foot. The coating preferably includes a binder such as gelatin.

The products of the invention may be produced by coating the non image side of the photographic material with an aqueous composition containing the mordant and a binder using known methods.

### FIELD OF THE INVENTION

This invention relates to the processing, and particularly to the washing or stabilizing of photographic material in which the material passes through a plurality of stages. The invention also relates to a novel photographic material having improved resistance to staining and also to a process for the production of the photographic material.

### BACKGROUND OF THE INVENTION

Silver halide photographic materials are well known and are processed to generate a silver or dye image by means of a development stage followed by a series of baths to stabilize and provide permanence to the image. Such baths convert and remove unwanted materials from the coated photographic layers which would either interfere with the quality of the final image or cause degradation of the image with time. In typical color systems the development stage is followed by a bleach stage to oxidize the developed silver to a form which can be dissolved by a fixing agent in the same or a separate bath. Such silver removal stages are then followed by a washing stage using water or other wash solution or a stabilization stage using a stabilizer solution. For convenience this last mentioned stage will hereafter be referred to generically as washing. Such stages remove residual chemicals and may also include conversion reactions between stabilizer solution components and materials within the coated layers. These stages are needed to give the required degree of permanence to the final image.

In many cases, particularly in small scale equipment known in the art as minilab or microlab equipment, the wash stage is performed in a multitank arrangement. Usually the replenishment of this stage, which keeps the concentration of substances removed from the photographic material at a constant and sufficiently low level, is carried out by adding fresh wash solution to the final tank of the sequence and arranging overflow from the final tank to flow into the previous tank and so on, the overflow from the first tank of this stage being then discarded as effluent. This is known in the art as a countercurrent mode of operation. This arrangement allows significantly lower amounts of solution to be used compared with one or two tanks especially when these are replenished separately.

In all of these arrangements processing is carried out with the photographic material immersed in a tank of solution even though many but not all, photographic materials are sensitised with an emulsion only on one side thereof.

### PROBLEM TO BE SOLVED BY THE INVENTION

As mentioned above the purpose of the wash stage is to remove dyes such as sensitising dyes and absorber dyes which would interfere with the quality of the final image. In the interests of rapid processing and of lower replenishment rates, the lower is the concentration of such species in a seasoned stabilizer bath, the better. The key parameters are time, number of tanks and replenishment rate. For a given number of tanks, higher replenishment and longer times provide for improved results but both of these parameters are ones that it is desirable to reduce.

U.S. Pat. No. 6,106,169 describes a washing process in which a series of baths are employed and in which the process is controlled so that, with the exception of the final bath, the baths do not achieve an equilibrium state between the sensitised material and the seasoned (steady state) condition of the bath. Controlling the wash process in this way enables the time in each bath to be reduced.

It has been previously proposed in German Patent No 19606456.2-51 to use a crossover wash i.e. to wash the film while it is passing from one tank to the next by means of solution flowing countercurrent to the film. This is operated to reduce the carry over by some but not all lengths of film and is claimed to result in a reduction in seasoned levels and thereby permit a reduction in the number of tanks and the length of the washing section of the process.

The present invention provides a different solution to this problem by the provision of a photographic material which has a coating layer containing a mordant to absorb during the processing the dyes such as absorber and sensitising dyes that contribute to staining of the final image.

### SUMMARY OF THE INVENTION

According to the present invention there is provided an opaque reflective photographic material having the non image side coated with a mordant in an amount to absorb, during washing of the photographic material dyes that contribute to staining of the final image.

### ADVANTAGEOUS EFFECT OF THE INVENTION

The photographic material of the invention enables the processing to be either faster, employ fewer washing stages or produce a higher quality image.

### BRIEF DESCRIPTION OF THE DRAWINGS

FIG. 1 shows the spectra obtained from mordants employed to absorb dyes in accordance with the invention

FIG. 2a and FIG. 2b compare mordant before and after soaking in stabilizer solution.

FIG. 2c and FIG. 2d compare mordant before and after soaking in stabilizer solution.

### DETAILED DESCRIPTION OF THE INVENTION

By photographic material we mean an opaque material for example paper which may produce a black and white or color image and may be in continuous web form or comprise discrete sheets.

The mordant which is preferably a colorless organic material which may be polymeric and will usually be a quaternary nitrogen-containing compound.

A suitable class of materials are quaternized vinylimidazole polymers and benzyl ammonium compounds, particularly those containing repeating units of polymerised 1-vinylimidazole and/or 2-alkyl-1-vinylimidazole which have been partly quaternized e.g. with 1-chloromethyl-carbonyloxy-2,3-dihydroxypropane.

Mordants suitable for use in the present invention are described in U.S. Pat. No. 4,229,915 and U.K. Patent Application No 2,093,041 which are hereby incorporated by reference.

In the case of nitrogen-containing polymers it is preferred that from about 5 to 35% more preferably about 10 to about 25% of the available quaternizable nitrogen atoms in the polymer are quaternized.

A suitable quaternizing agent is chloroethanol or an analogue thereof although other agents such as benzyl chloride and its analogues may be used.

Copolymer mordants made by the quaternization of copolymers of N-vinylimidazole and vinylpyrrolidone are also effective.

In the case of polymer mordants the molecular weight may vary within wide ranges. Polymers with molecular weights in the range about 10,000 to about 100,000 may be used.

Polyvinylimidozoles used in the present invention typically have a molecular weight of about 15,000 to about 30,000.

The mordant is conveniently coated to provide a lay down of from 100 mg/square foot to 400 mg/square foot, preferably from 150 to 300 mg/square foot.

The coating also preferably contains a binder e.g. gelatin in an amount to give a ratio of mordant to binder of from about 1:3 to about 3:1.

In a preferred embodiment of the invention the photographic material is a paper having the non image side coated with a mordant which is capable of absorbing during washing of the photographic material dyes that contribute to staining of the final image.

According to another aspect of the invention there is provided a process for the production of a photographic material having improved resistance to staining which process comprises depositing on the non image side of the photographic material a mordant capable of absorbing during washing of the photographic material dyes such as absorber and sensitising dyes that contribute to staining of the final image.

The coating of the photographic material e.g. paper may be effected before the emulsion layer(s) are applied. Therefore included within the scope of the present invention are photographic materials such as paper having one side coated with the mordant and the other side ready to receive the emulsion layer(s).

The application of the coating is conveniently effected dispersing the mordant in water together with a binder such as gelatin optionally together with a hardener and surfactant and coating the photographic material by standard methods known for coating photographic materials. The photographic material in the form of a moving web may for example be passed by a hopper from which the dispersion of mordant is continuously fed. A spreading means may be employed to ensure a uniform coating.

The mordant is preferably deposited to form a coating at a lay down of from 100 to 400.mg/square foot, more preferably 150 to 300 mg/square foot of the photographic material.

According to another aspect of the invention there is provided a washing process for photographic materials which comprises subjecting a photographic material as hereinbefore defined which has been subjected to the stages of development and fixing to a washing stage and allowing the mordant to absorb dyes such as absorber and sensitising dyes present in the wash solution that would contribute to staining of the final image.

The invention is illustrated by the following Examples.

### EXAMPLE 1

Preparation of Photographic Paper Having Mordant Coating.

Poly(1-vinylimidazole)₄-co-(1-vinyl-3-(2-ydroxyethyl)imidazoliumchloride)

The title polymer (4g) dissolved in water (150 ml) was added to an aqueous gelatin solution (12.5%, 32g) at 40 degrees C. The pH of the mixture was adjusted to 5.5 by the addition of dilute hydrochloric acid. After the additions of the hardeners and surfactants the volume of the mixture was made up 200 ml with deoxygenated water prior to coating onto the photographic material.

The mixture is coated onto the non image side of EKTACOLOR (Registered Trade Mark) paper using the standard coating method known for coating photographic elements such as paper.

The following structure was obtained:

| | |
|---|---|
| Polymer (200) | hardener 1 (10) |

surfactant (10)

| | |
|---|---|
| Gelatin (200) | hardener 2 (10) |

Paper

The numbers in brackets refer to coating weights of each component in mg/square foot.

Hardener 1 was formaldehyde and hardener 2 was Araldite diluent DY022 active constituent butane-diol-di-glycidyl ether.

Surfactant was nonyl phenoxypolyglycidol N-10.

### Example 2

Absorption of Dyes by Mordants

Coatings of mordants 1 and 2 on clear Estar film base were prepared as described above in Example 1 and were then soaked in seasoned stabilizer solution (RA4) for 100 seconds and then washed for several minutes with cold Harrow tap water. They were dried and their spectra recorded. \

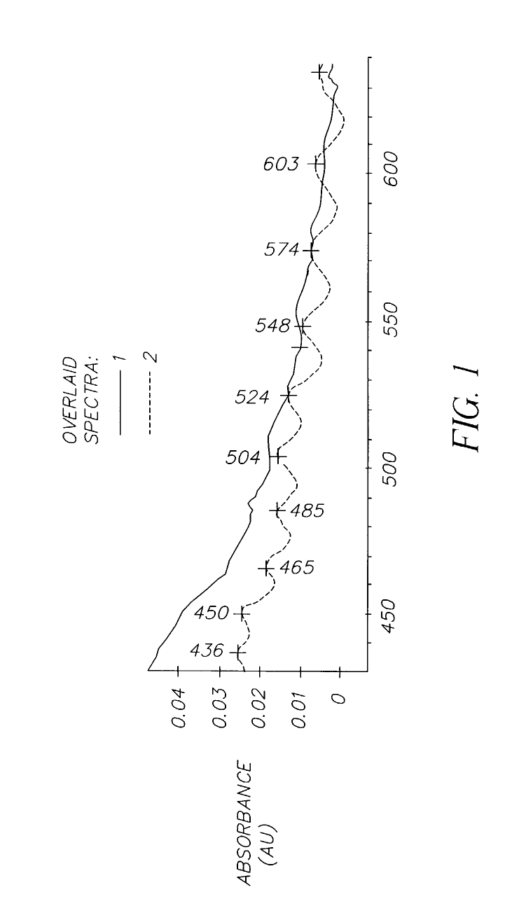

The data is shown in Table and FIG. 1. The spectra in FIG. 1 show that several dyes were absorbed permanently by the mordant and in particular coating (2) displays 10 separate absorption peaks showing absorption of sensitising and absorber dyes used in EKTACOLOR (Registered Trade Mark) and other coloured components seasoned into the process while processing KODAK (Registered Trade Mark) EKTACOLOR (Registered Trade Mark) paper.

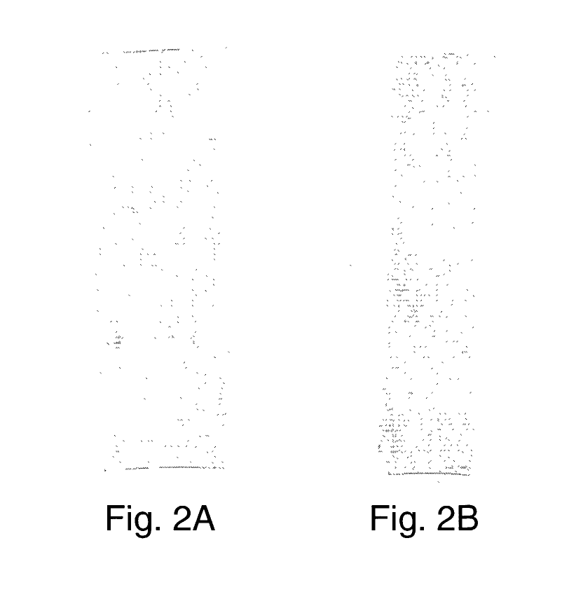

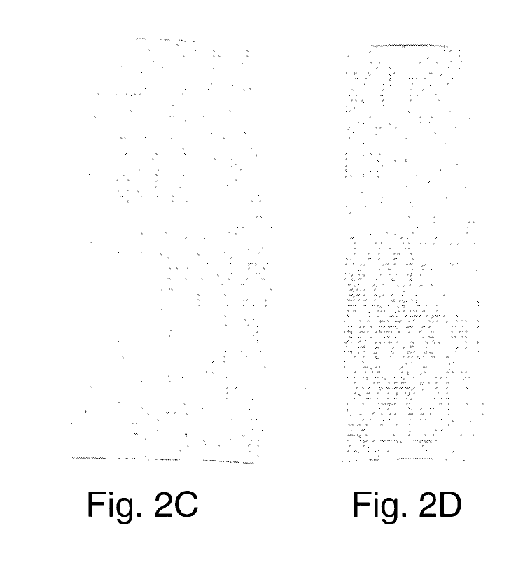

The upper pair of specimens in FIG. 2a and FIG. 2b are Estar film base coated with mordant (1) and the lower pair in FIG. 2c and FIG. 2d are coated with mordant (2). The right hand specimen shows the dye absorbed in each case when the specimens were soaked in seasoned RA 4 stabilizer solution, washed and dried.

The left hand specimens were not subjected to the soaking and are included for comparison.

This Example shows that mordant coated on the reverse of EKTACOLOR (Registered Trade Mark) paper can be used to remove significant levels of dyes whose presence limit the washing replenishment rates and times. By removing these dyes the process will benefit by either reduced staining of the product or the same product produced with a washing stage having a lower replenishment rate or shorter time.

(1) was a coating of 210 mg/square foot of polyvinyl imidazole, approximately 20% quaternized in 210 mg/square foot of gelatin and

(2) was a coating of 200 mg/square foot of 49.5% N-N dimethyl-N-benzyl-N-4-vinylbenzyl ammonium chloride and 49.5% polystyrene, in 200 mg/square foot of gelatin.

The photographic materials in the above Examples enable the process of removing the dyes from the wash baths to be fully automatic and no operator intervention or even operator awareness is required.

TABLE 1

| Mordant | Peaks | Abs (AU) |
|---|---|---|
| 1 | 487.0 | 0.0237 |
| 1 | 507.0 | 0.0187 |
| 1 | 554.0 | 0.012 |
| 1 | 573.0 | 0.0092 |
| 1 | 579.0 | 0.0089 |
| 1 | 603.0 | 0.006 |
| 1 | 641.0 | 0.0056 |
| 1 | 633.0 | 0.005 |
| 1 | 657.0 | 0.0047 |
| 2 | 436.0 | 0.251 |
| 2 | 450.0 | 0.243 |
| 2 | 465.0 | 0.0182 |
| 2 | 485.0 | 0.0167 |
| 2 | 504.0 | 0.0163 |
| 2 | 524.0 | 0.0135 |
| 2 | 548.0 | 0.0103 |
| 2 | 574.0 | 0.0087 |
| 2 | 603.0 | 0.008 |
| 2 | 635.0 | 0.0073 |

The invention has been described in detail with particular reference to certain preferred embodiments thereof, but it will be understood that variations and modifications can be effected within the spirit and scope of the invention.

1. An opaque reflective photographic material having an image side and a non-image side, said non-image side being coated with a mordant in an amount to absorb during washing of the photographic material dyes that would contribute to staining of the final image.

2. A photographic material as claimed in claim 1 wherein the image side is coated with one or more layers of a light sensitive silver halide emulsion.

3. A photographic material as claimed in claim 2 wherein said light sensitive silver halide emulsion layer has associated therewith one or more dyes selected from absorber dyes and sensitising dyes.

4. A photographic material as claimed in claim 1 wherein the mordant is a quaternary nitrogen-containing compound.

5. A photographic material as claimed in claim 1 wherein the mordant is a quaternized vinylimidazole polymer or vinyl benzylammonium compound.

6. A photographic material as claimed in claim 1 wherein the mordant is coated at a lay down of from 100 to 400 mg/square ft.

7. A photographic material as claimed in claim 1 wherein the mordant is coated at a lay down of from 150 to 300 mg/square foot of the photographic material.

8. A photographic material as claimed in claim 1 wherein the coating includes a binder.

9. A photographic material as claimed in claim 8 wherein the binder is gelatin.

10. A photographic material as claimed in claim 1 wherein the material is a paper support.
